(19) United States
(12) Patent Application Publication
(10) Pub. No.: US 2002/0010007 A1
(43) Pub. Date: Jan. 24, 2002

(54) Method and means for a portable device in a wireless communication system

(75) Inventors: Peter Goodings, Glossop (GB); Gary Denman, Lancaster (GB)

Correspondence Address: JENKENS & GILCHRIST, 3200 Fountain Place, 1445 Ross Avenue, Dallas, TX, 75202-2799, US

(73) Assignee: Telefonaktiebolaget L M Ericsson (publ)

(21) Appl. No.: 09/882,866

(22) Filed: Jun. 15, 2001

Related U.S. Application Data
(60) Provisional application No. 60/212,311, filed on Jun. 16, 2000.

(51) Int. Cl. H04M 1/00

(52) U.S. Cl. 455/566; 455/575

(57) ABSTRACT

A method and apparatus for saving and storing data in a data record of an application into a memory storage in a portable device in a wireless system. The method comprises the steps of detecting a mode change from a second mode to a first mode during edit view, saving and storing data from the edit view as a response to said mode change from a second mode to a first mode during edit view. According to an aspect of the invention said mode change can be executed by changing a flip coverage of the device from open to closed.

### RELATED APPLICATION(S)

This application claims the benefit from, and hereby incorporates by reference the entire disclosure of co-pending U.S. provisional application Ser. No. 60/212,311 filed on Jun. 16, 2000.

### TECHNICAL FIELD

The present invention relates to a method and apparatus related to a portable device in a wireless system.

### BACKGROUND

Portable devices such as personal communicators in wireless communication systems and mobile radio communications systems are known that have data and voice function. Personal communication systems are also often designed to function in a multimedia environment for the transmission of images and data and other various multimedia services. Multimedia services may be defined as wireless services such as visual display of data, interactive video, wireless note pad and similar type wireless services.

An example of an earlier known personal communicator is taught in U.S. Pat. No. 5,414,444. A housing of the communicator includes the necessary electrical, video and radio circuitry. The communicator includes a hinged member or keyboard support. The open or closed state of this hinged member determines the primary operative mode of the communicator. In the closed position of the hinged member, the communicator is switched to its communicator (i.e. cellular) mode. With the hinged member in its open position, the communicator is operative in a multimedia mode. The change in modes is controlled by a switch or position responsive device in the hinge, which controls the mode selected in response to the hinged member position. The communicator has a high resolution color touch screen graphic display. The underside of the hinged keyboard support includes a plurality of key probes that respond to the push button input keys to apply pressure to touch sensitive areas of a touch screen of the touch screen graphic display.

Wireless communicators and other mobile radio devices are known that have a Man-Machine-Interface (MMI), but the MMI differs from model to model and manufacturing company. It is important to design the MMI in such a way that it makes the device easier to handle. The invention of this application relates to saving methods, and a method for making it easier for a user to save and store data that has been inserted in an application during the editing of a data record but which has not been stored into the record.

### SUMMARY

Users often feel that it is a very complex and time-wasting process to save data into a data record or data base, etc., of an open program application in ordinary portable wireless communication devices. If a user is in a hurry, for example, when a person is sitting in a bus and is writing data into a portable device, and the person suddenly has to jump off the bus, it is desirable to save amendments to a data record and to finish the application by an easy process.

The purpose of the method of the invention is to provide an easy and time-saving solution. According to an aspect of the invented method and apparatus, when a user closes the flip of the device, amended data will be saved and stored automatically and the running application will be closed.

More particularly, the invention is a method and an apparatus for saving and storing data to a data record of an application in a memory storage of a device for mobile radio communication, wherein the method comprises the following steps:

detecting a mode change from a second mode to a first mode during edit view;

saving and storing data from the edit view in response to the mode change from a second mode to a first mode during edit view.

One advantage of the invention is that a user need not find the correct menus for saving data and for closing the application. Instead, data is saved and the application is closed in an easy and fast method, which is responsive to the position of the flip.

### BRIEF DESCRIPTION OF THE DRAWINGS

FIG. 1 is a front elevational view of a mobile radio device;

FIG. 2 is a plan view of a mobile radio device in an open position;

FIG. 3 is a block diagram of a mobile radio device;

FIG. 4 is a flow chart of one aspect of the method of the invention; and

FIG. 5 is a flow chart showing another aspect of the method of the invention.

### DETAILED DESCRIPTION

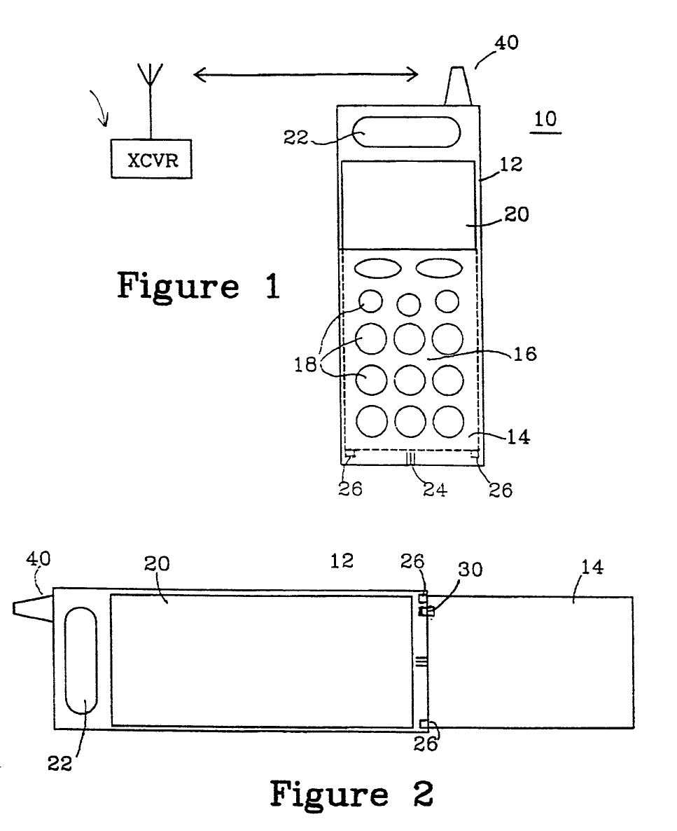

Referring now to FIG. 1, FIG. 1 shows a front view of a portable electronic device in the form of mobile radio device 10. The mobile radio device 10 (also called a radio terminal, mobile station, personal communicator, handy or mobile phone) is shown working in a communication system. The system includes a number of locally fixed radio base stations each handling the radio traffic associated with all reachable mobile radio communication devices 10 within its geographic service area. Each radio communication device 10 has an antenna 40 and a radio device system comprising necessary radio circuits. The radio device 10 has a main housing 12 and a lid/flip 14 that is movable in relationship to the main housing 12. The flip 14 has input means, for example a key pad 16, with a plurality of keys 18 that correspond to desired functions, numbers or characters.

Main housing 12 has an information input means and information displaying means that preferably can be combined with, for example, a touch screen display 20, which is partly obscured by flip 14 when flip 14 is folded up against main body 12 and when the flip is defined to be closed. Main body 12 has a loudspeaker 22 and a microphone 24. A battery pack is attached to the underside of the main housing and it provides electrical power to the circuitry of the device.

In one embodiment, keys 18 generate electric signals when they are depressed against their corresponding contacts on a printed circuit board, PCB.

In another embodiment, the keys 18 protrude through the flip 14. When the flip 14 is closed and a user depresses a key 18, keys 18 contact a portion of touch screen display 20 beneath them. The touch screen display 20 detects which key 18 has been pushed into contact with it and carries out the desired operation. Touch screen display 20 can also display information.

FIG. 2 shows a plan view of device 10 in which flip 14 has been folded down from main body 12 about hinge 26. This position of the flip 14 is defined as the open position. Touch screen display 20 is fully exposed when flip 14 is in the open position.

In one embodiment, the hinge 26 contains a flip position indicating hinge switch 30, which is closed when flip 14 is in a closed position. In the open position, flip 14 no longer covers the touch screen 20 and keys 18 have no function because they are separated from the touch screen 20. Each part of the surface of the touch screen 20, which is covered by one of the keys 18 when the flip is closed, can be given different functions depending on whether the flip 14 is open or closed. When the flip 14 is closed, each key 18 has a specific function assigned to it. Software included in the device 10 determines the function of each key 18.

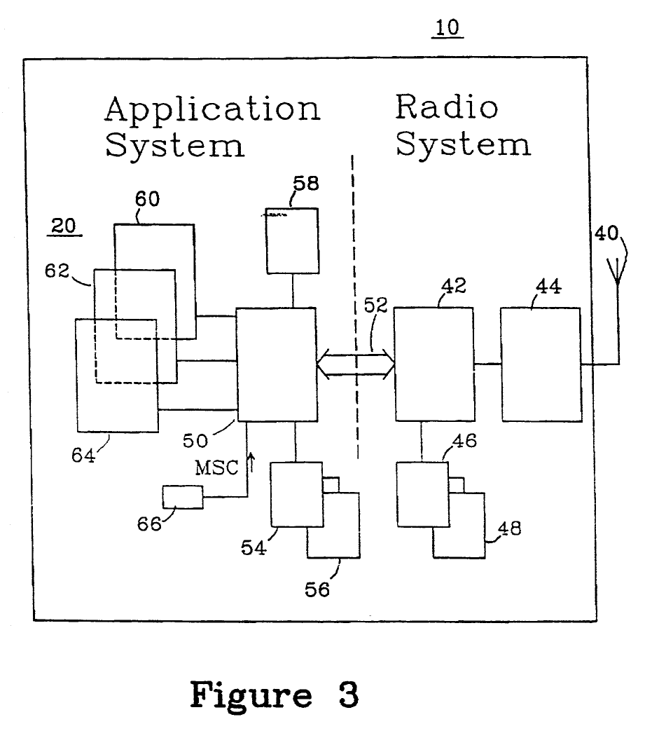

Referring now to FIG. 3, FIG. 3 shows a block diagram of an embodiment of a mobile radio device 10 in a mobile radio communication system. Each radio communication device 10 has an antenna 40 and a radio device system comprising necessary radio circuits 44 and a radio controller 42. The radio controller 42 is a data processing unit, e.g. at least one central processor and/or microprocessor. The radio controller 42 is connected to software and data memory storages 46,48, for example, a FLASH memory and a RAM.

In a preferred embodiment of the invented device 10, the controller 42 is also connected via a data bus 52 to an application system. The application system comprises an application controller 50, different memory storage 54, 56 and in-/output units 58-66 connected to the controller 50. The application system manages functions both directly related to the functions of the radio system and functions not related to the radio system. Telephony, calendar, messaging, address book, accessories, system tools, internet, Bluetooth™ and WAP are some examples of application functions that can be included in the application system. The application controller 50 uses function software and data stored in memory storage media 54 (e.g. a FLASH memory) and the controller 50 is connected to a working storage like an SDRAM 56 (Synchronous Dynamic Random Access Memory). A user enters data from a keyboard 58 and/or a touch screen (TS) 64, both controlled by and connected to the application controller 50. Output data is presented on a display 20, 62. In this embodiment, a liquid crystal display (LCD) 62 is used in combination with the touch screen (TS) 64 and a backlight unit (BU) 60. Although FIG. 3 shows the BU 60, LCD 62 and TS 64 as separate units, they are actually combined into one single unit 20. BU 60, LCD 62 and TS 64 are all connected via data busses to the application controller 50. The single unit 20 is called a touch screen display (TSD).

Different applications are presented and available to choose on the TSD 20 for the user, who can point/“click” on menus or application icons for starting a desired application program. When an application is running, the user can enter an edit view and amend already existing information or write new information to be stored in a file, record, list or database that is associated with the chosen application. An entry view displays information about a particular application record. An edit view allows the user to modify an existing record. The edit view is an input window or document having at least one input area displayed on the TSD 20. In the edit view, the user writes the information that he wants to be stored on the TSD 20 using a suitable tool, e.g., a pen. When no more information is to be written into the record, file or document, the user saves and stores the information by ordering a saving procedure by pointing with the tool to a save command display in a menu or accept button displayed somewhere on the display.

An aspect of the invented device for mobile radio communication has a method for saving and storing data in a data record of an application into a memory storage. The invention comprises a method for changing modes from a first mode to a second mode, a method for starting an application in the second mode, and a method for opening an edit view for receiving data. The device also comprises a method for detecting a mode change from a second mode to a first mode during an edit view and a method for saving and storing data from the edit view screen as a response to the mode change from a second mode to a first mode during edit view. As shown in FIGS. 1 and 2, the terminal has a pivotable flip 14 that partially covers the TSD 20 when the flip 14 is closed. This can be defined as a first mode or flip closed mode. When the flip 14 is fully opened, the TSD 20 is totally uncovered and this state is defined as a second mode or flip open mode. In one preferred embodiment of the invention, flip 14 is the implementation of the method for changing modes from a first mode to a second mode. The other method, i.e., the method for starting an application in the second mode, a method for opening an edit view for receiving data, a method for detecting a mode change from a second mode to a first mode during edit view and a method for saving and storing data from the edit view screen in response to the mode change from a second mode to a first mode during edit view, are executed by software that is stored in the storage media 54 and used by the application controller.

In one embodiment, the mode change generator 66 (FIG. 3) is coupled to the flip 14 and generates a mode change signal (MSC) that is received by the application controller 50 every time that the flip 14 is opened or closed. The signal can either be a pulse or constant signal that changes from a high to low voltage depending on whether the flip 14 is opened or closed.

A mode change generator 66 can be a switch having two different states. The switch generates a signal having two different states, each corresponding to one of the switch states.

The application functions of the mobile radio device 10 can be separated into two different sets of applications. A user can change from one first set of applications to a second set by changing the mode from a first mode when the flip is closed to a second mode when the flip is opened.

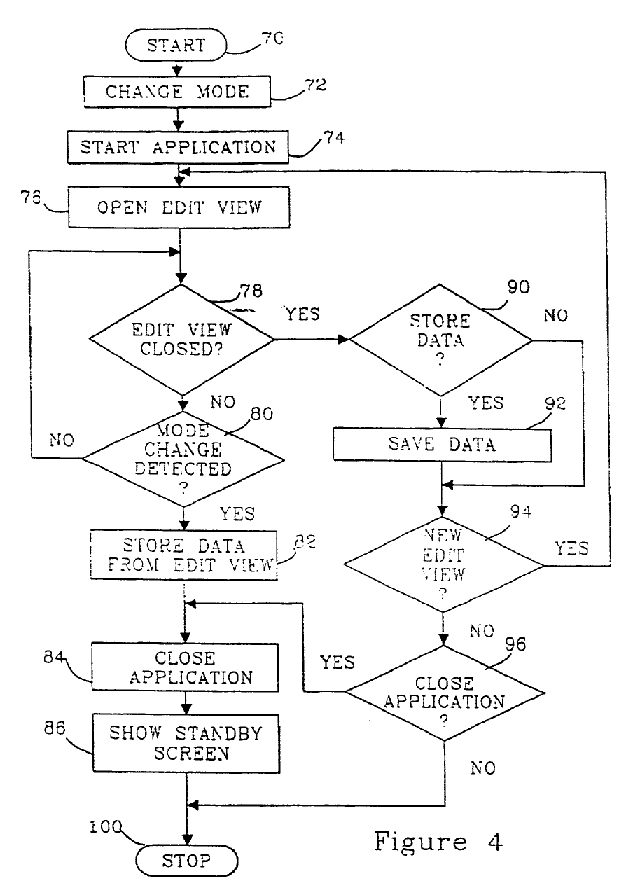

Referring now to FIG. 4, a method of the invention is described by a flow chart. The application system controller 50 is programmed to perform a method for saving changes of an edit view of an application. The first step 72 of the method is a step of detecting a mode change from a first mode to a second mode. A user can activate mode change generator 66, which produces a mode change signal (MCS) that can be detected by the controller 50. In the next step 74, the controller starts a user-selected application. An edit view of the application may be opened as indicated in step 76. The application system can receive data as long as the edit view is not closed, which is checked in step 78, or a mode change from the second mode back to the first mode is not detected (NO), which is checked in step 80.

If the edit view is closed/terminated (YES) before a mode change is detected, step 90 is executed and the application system displays a question if the new data is to be stored (YES) or deleted (NO). Depending on the response of the user, step 92, i.e., “save data”, or step 94, i.e., “new edit view”, is to be executed next. If the user chooses to store the data, the data is saved in step 92 before the application controller executes step 94. If the response is NO to the “store data” query of step 90, the system will not save any amendments to the record and move to step 94. In step 94 the system checks whether the user wants to change another data record by opening a new edit view window and loading a new record (YES) or not (NO). If the user responds YES to the query of step 94, the method and the system will return to step 76 for opening a new edit view. If NO, the controller will display a question if the application is to be closed in step 96. If a user responds NO to the query of step 96, step 100 is executed and the saving and storing procedure is terminated. At this point, the application is still open for performing other functions of the application. If instead the response is YES to the query of step 96, the controller proceeds with step 84 and automatically closes (terminates) the application. In the next step, step 86, the application controller will navigate the display to show a standby screen for telephone functions on the display unit. The saving and storing procedure stops in step 100, but the application is still open for performing other functions of the application.

However, according to the loop consisting of step 78 and 80, if a mode change from the second mode to the first mode is detected, i.e., YES in step 80, the amendments of the edit view window are saved and stored to the existing records in step 82. The controller proceeds with step 84 and automatically closes(terminates) the application. In the next step, step 86, the application controller will navigate the display to show a standby screen for telephone functions on the display unit. The saving and storing procedure stops in step 100.

In general, when the user closes the flip, the display shall automatically navigate to the standby screen/window.

If an edit view is displayed prior to the flip being closed, the application shall make any changes persistent.

If a delete confirmation message is displayed prior to the flip being closed, the application shall act as if the action was not confirmed.

If a save confirmation message is displayed prior to the flip being closed, the application shall act as if the action was confirmed.

If an event message is displayed prior to the flip being 20 closed, the equivalent event message shall be displayed when the flip is closed.

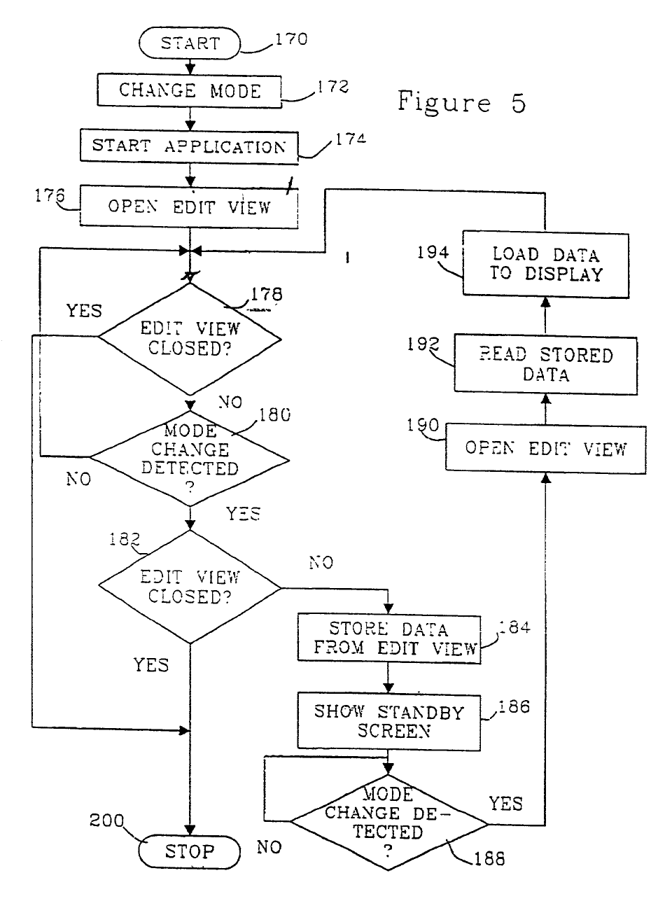

Finally, an extended method for saving and recalling saved data will be presented according to the flow chart in FIG. 5. This method will be described in more detail below. The application system controller 50 is programmed to perform a method for saving changes of an edit view of an application. The first step 172 of the method, is for detecting a mode change from a first mode to a second mode.

A user can activate mode change generator 66, and the generator produces a mode change signal MCS that could be detected by the controller 50. In the next step 174, the controller starts a user-selected application. An edit view of the application is then opened, as indicated by step 176. The application system can receive data as long as the edit view is not closed, which is checked in step 178, or a mode change from the second mode back to the first mode is not detected (NO), which is checked in the next step 180. If the edit view is closed/terminated (YES) before a mode change is detected, the new data is stored or deleted depending on the choice of the user and the method ends, as indicated in step 200.

If it is determined that the edit view was for some reason closed in step 182, the controller stops the running of the programmed method in step 200. If a mode change from the second mode to the first mode is detected (YES) in step 180 and the edit view is not found to be closed (NO) in step 182, the amendments of the edit view window are saved and stored to the existing records as indicated in step 184. The application system can set the running application in a standby state. The application controller will navigate the display to show a standby screen, as indicated in step 186, for telephone functions.

In step 188, the application controller will wait, i.e., execute a loop to determine if a new mode change is detected. If a mode change from the first mode to the second mode is detected (YES) in step 188, the next step 190 will follow. In step 190, the last edit view screen is displayed again instead of the standby screen. The stored data is then read from storage, as indicated by step 192 and loaded to the display unit in the following step 194. The process is now back to the step 178 where data can be received and new data can be added to the loaded and displayed data. The procedure can now be repeated until the application is closed/terminated in “stop” step 200. No data will be lost. The above described procedure is preferably implemented as software in the application system.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for storing data in a wireless communication device comprising the following steps:
starting an application in a second mode;
opening an edit view for receiving data;
displaying said data received in said edit view;
changing from said second mode to a first mode;
detecting said mode change during said edit view; and
storing said data from said edit view in response to said mode change.

2. The method for saving according to claim 1, wherein:
the wireless communication device is in said first mode when a flip of said wireless communication device is in a closed position and said wireless communication device is in said second mode when said flip of the wireless communication device is in an open position; and
said mode change is accomplished by changing a position of said flip.

3. The method for saving according to claim 2, further comprising the step of:
closing said application automatically after said mode change.

4. The method for saving according to claim 2, further comprising the step of:
closing said application automatically after said mode change; then
showing a standby screen on a display of the wireless device.

5. The method for saving according to claim 1, further comprising the steps of:
waiting for a mode change from said first mode to said second mode;
opening said edit view again if a mode change from said first mode to said second mode is detected;
reading the stored data from the memory storage; and
loading said data to a display unit.

6. The method according to claim 1 wherein:
said steps are implemented as software that is stored in a storage media and used by an application controller.

7. The method according to claim 1, wherein:
said steps of changing from a first mode to a second mode comprises moving a flip to activate a mode change generator.

8. The method according to claim 7, wherein:
said mode change generator generates a mode change signal when a position of said flip is changed.

9. The method according to claim 8, wherein:
said mode change generator is a switch.

10. The method according to claim 5, wherein:
said steps of waiting, opening, reading and loading are implemented by software that is stored in a storage media and used by an application controller.

11. The method according to claim 10, wherein:
the wireless communication device includes at least two sets of applications;
at least one of said applications is available in only one of said sets of said applications; and
a change between said sets of said applications is accomplished when a mode change is detected by said application controller.

12. A mobile radio device comprising:
a touch screen on a main housing;
a switch, said switch having a first position and a second position;
a mode change generator responsive to said switch, said mode change generator operable to produce a mode change signal; and
a memory storage operable to store data upon receiving said mode change signal from said mode change generator.

13. The mobile radio device according to claim 12 further comprising:
a flip rotatably attached to said housing, said flip positionable in an open position and a closed position;
wherein said switch is activated by a position of said flip; and
wherein said closed position of said flip corresponds to said first position of said switch and said open position of said flip corresponds to said second position of said switch.

14. The mobile radio device according to claim 12 further comprising:
a plurality of fixed radio base stations for handling radio traffic associated with the mobile radio device when said switch is in said first position.
